(19) United States
(12) Patent Application Publication
(10) Pub. No.: US 2018/0173939 A1
(43) Pub. Date: Jun. 21, 2018

(54) RECOGNITION OF OBJECTS WITHIN A VIDEO

(71) Applicant: Jonathan Howe, SALISBURY, WILTSHIRE (GB)

(72) Inventor: Jonathan Howe, SALISBURY, WILTSHIRE (GB)

(21) Appl. No.: 15/127,490

(22) PCT Filed: Mar. 19, 2015
(86) PCT No.: PCT/GB2015/000096

§ 371 Date: Sep. 20, 2016

(30) Foreign Application Priority Data
Mar. 21, 2014 (GB) 1405045.4

(51) Int. Cl. G06K 9/00; G06K 9/62

(52) U.S. Cl. CPC G06K 9/00288; G06K 9/6218; G06K 9/6201

(57) ABSTRACT

There is provided a method for recognition of objects within a video, the video comprising a plurality of video frames. The method comprises detecting a plurality of object images present in the video frames; determining comparison scores between pairs of the object images; determining correlation scores between pairs of the object images, the correlation scores being correlations between the comparison scores; grouping the object images into groups of object images that show the same object as one another based on the correlation scores; and for at least one of the groups, using the object images of the group as object images of a single object in an object recognition process. —There is further provided a system for recognition of objects within a video.

### TECHNICAL FIELD OF THE INVENTION

This invention relates to the recognition of objects within a video, in particular a video comprising a plurality of video frames. The objects may for example be human faces.

### BACKGROUND TO THE INVENTION

The recognition of objects within video is useful for a wide variety of applications, for example video surveillance, “tagging” of people appearing in the video, cataloguing of videos.

Video object detection refers to the detection of images of particular type(s) of object within a video, for example a video object detector may be configured to search for images of human faces, animals, vehicles, or text. Accordingly, the video object detector may signal when an object of a desired type is present within the video. Various video object detection techniques are known in the art, and in the case of searching for objects that are faces, may utilise face detecting algorithms such as Haar wavelets and PCA (Principal Component Analysis).

Video object recognition refers to recognising that a detected image of an object actually corresponds to a particular object or sub-type of objects, for example a facial image may be recognised as being of a face of a particular person, an animal image may be recognised as being of a particular species of animal, a vehicle image may be recognised as being an image of a particular vehicle, or a textual image may be recognised as a brand name of a particular company. Video object recognition is typically carried out by comparing the image of the object to a library of possible objects to determine which of the possible objects the image of the object shows. For example in the case of video face recognition, a detected facial image may be compared with each one of a library of facial images/models of known persons, to determine the face, and therefore the person, that is shown in the facial image.

Various video face recognition techniques are known in the art, and these typically aim to track a particular face through successive video frames, so that multiple facial images of the same face can be gathered together to improve the matching of facial images to faces. Clearly, if several facial images of one person are provided, then face recognition can be performed more accurately than if only one facial image was provided. For example, the results from the several facial images may be averaged to identify a person with a higher level of certainty than if only one facial image was used. The same applies to animals and vehicles, for example if multiple images of the same animal are gathered together then the likelihood of identifying the correct animal species from the animal images is higher than if only one image of the animal was provided.

US2010/0316298 discloses a method for tracking multiple faces through a video. Initially, a face image is detected in a video frame, and then the face is tracked through subsequent video frames to form a track. Each track has an appearance model of the face being tracked, and the track is formed by searching subsequent video frames for face images matching the appearance model. The search is restricted to areas of the subsequent video frames where the face is likely to be found, based on motion estimation. This is one example of the combination of detection and comparison algorithms into a spatio-temporal model of the face using a Kalman or particle filter.

However, the use of an appearance model involves a determination of whether a particular face image falls within the scope of one appearance model, or falls within the scope of another appearance model, and is prone to categorizing face images incorrectly when the face images are noisy and/or when the appearance models are fairly similar to one another.

Furthermore, more than one track may be created for a given person, particularly if the person's face is occluded behind other objects for part of the video, if the scene recorded in the video is cluttered, or if the video comprises video frames that were taken at significantly different times or places. This can result in incomplete tracks that miss out facial images that could have been useful for carrying out face recognition operations on the track. To increase accuracy in these situations, further complex models need to be used which can be computationally expensive.

It is therefore an aim of the invention to provide an improved method of recognising objects within a video.

### SUMMARY OF THE INVENTION

According to a first aspect of the invention, there is provided a method for recognition of objects within a video, the video comprising a plurality of video frames. The method comprises detecting a plurality of object images present in the video frames; determining comparison scores between pairs of the object images; determining correlation scores between the pairs of the object images, the correlation scores being correlations between the comparison scores; grouping the object images into groups of object images that show the same object as one another based on the correlation scores; and for at least one of the groups, using the object images of the group as object images of a single object in an object recognition process.

Each comparison score indicates a level of similarity between two object images forming one of the pairs, and is typically calculated by comparing the two object images to one another. The comparison scores may for example be match scores ranging between a value of zero for no match between the two object images and a value of 1 for a 100% match between the two object images. Alternatively, the comparison scores may be likelihood ratio scores indicating the likelihood that the two images are images of the same object.

A genuine comparison score is defined as a comparison score between a pair of object images that are of the same object, and an imposter comparison score is defined as a comparison score between a pair of object images that are of two different objects. Clearly, the pairs of object images giving genuine comparison scores need to be separated from the pairs of object images giving imposter comparison scores, because each pair of object images giving a genuine comparison score are by definition object images of the same object, and are therefore useful for comparing in tandem against a library of known objects for object recognition.

The genuine comparison scores between multiple facial images of the same face typically have a Gaussian distribution characterised by a mean and a standard deviation. The imposter comparison scores between multiple facial images of different faces also typically have a Gaussian distribution characterised by a mean and a standard deviation. In low quality video, the distributions of the genuine comparison scores and the imposter comparison scores may significantly overlap with one another, such that some of the genuine comparison scores are lower than some of the imposter comparison scores, and such that the setting of a particular threshold value of comparison score for separating genuine comparison scores from imposter comparison scores is not very effective.

The two-stage process according to the invention of determining comparison scores and then determining correlation scores based on the comparison scores has been found to improve the separation between the genuine comparison scores and the imposter comparison scores, such that the detected images can be more easily split into separate groups, each group comprising images of a corresponding object.

The correlation score between a pair of the object images, referred to as first and second object images, may be calculated by correlating the comparison scores between the first object image and the plurality of object images, with the comparison scores between the second object image and the plurality of object images. If the comparison scores between the first object image and the plurality of object images vary in the same way as the comparison scores between the second object image and the plurality of object images, i.e. if the comparison scores have a high correlation, then it is more likely that the first and second object images are images of the same object.

Typically, the more video frames that are used to collect object images, the more object images that are detected, and the more comparison scores that are calculated. The more comparison scores that are calculated, the more comparison scores that are used in the calculation of the correlation score for each pair of object images, and so the more effectively the correlation score helps to determine whether or not the pair of object images are of the same object. When large numbers of video frames are used, the calculation of the correlation between the comparison scores can help to separate genuine and imposter comparison score distributions even for very noisy or low quality video frames.

The video frame rate is preferably high enough to provide multiple object images of each object that appears within the video. The method will result in a set (for example a vector) of correlation scores being calculated for each one of the multiple object images, and the multiple object images may be grouped into a group based on the sets of correlation scores being similar to one another. The more object images there are of each object, the more sets of correlation scores there will be for each object, and the more effectively the grouping can be carried out. Also the more object images of the same object there will be available for use in the object recognition process, improving the effectiveness of the object recognition process.

Advantageously, the detection of object images present in the video frames may comprise detecting object images along a scanning path across each video frame, the scanning paths across the video frames being the same as one another. Therefore, successive object images detected from a video frame may show the objects of the video in a pattern that is repeated for each subsequent frame, particularly when relative movements between the objects from frame to frame are low. Due to this repeating pattern, the effect of the correlation helping to separate the image pairs forming the genuine comparison scores and the image pairs forming the imposter comparison scores may be improved. The repeating pattern will inevitably vary over time as new objects enter the video, as existing objects change position within the video, and as some objects leave the video, although the frame rate of video is usually high enough compared to the movements of objects for patterns to repeat over subsequent frames.

The plurality of object images may be arranged into an object image list in an order corresponding to an order in which the object images are detected from the video frames. For convenience, the scanning path may for example be a path that starts at the top left of the video frame and extends from left to right along successive rows of pixels until the bottom right of the image is reached. Any other arbitrary path through the video frame may also be chosen, with the path remaining the same for subsequent video frames. The path is preferably arranged to scan through the full area of the video frame to reduce the chances of failing to detect any object images appearing in the video frame.

The determination of comparison scores between pairs of the object images may comprise determining a comparison vector for each object image, the comparison vector comprising comparison scores between the object image and the other object images (generally all of the other object images). Specifically, each detected object image may be compared to other ones of the object images to determine a respective comparison vector of comparison scores between the object image and the other object images.

For example, a first one of the detected facial images may be compared to the other detected facial images to determine a first vector of comparison scores between the first detected facial image and each one of the other detected facial images; a second one of the detected facial images may be compared to the other detected facial images in the same order as for the first detected facial image, to determine a second vector of comparison scores between the second detected facial image and each one of the other detected facial images; and a correlation score between the first and second vectors may be calculated to indicate a level of correlation between the first and second images, the calculation of the correlation exploiting the order in which the facial images are arranged to aid in identifying object image pairs that are of the same object.

Conveniently, the plurality of object images may consists of N object images, the object image list may be an N length object image list; and determining comparison scores between pairs of the object images may comprise determining an N:N comparison matrix containing comparison scores between each one of the plurality of object images and every other one of the plurality of object images. The rows and columns of the N:N comparison matrix define the comparison vectors, each comparison vector being associated with a respective one of the object images, each comparison vector being a vector of comparison scores that are calculated between the respective object image and the other object images.

Advantageously, determining correlation scores between pairs of the object images may comprise determining a correlation vector for each object image, the correlation vector comprising correlation scores between the comparison scores of the object image and the comparison scores of the other object images. Determining correlation scores between pairs of the object images may comprise determining correlation scores between pairs of the comparison vectors. Specifically, each comparison vector may be correlated with every other comparison vector to determine a respective correlation vector of correlation scores between the comparison vector and the other comparison vectors, each correlation score indicating a likelihood of the object image corresponding to the comparison vector being of the same object as the object image corresponding to the other comparison vector.

Conveniently, determining correlation scores between pairs of the object images may comprise determining an N:N correlation matrix containing correlation scores between each one of the comparison vectors and every other one of the comparison vectors, the rows and columns of the N:N correlation matrix defining the correlation vectors.

The grouping of the object images into groups may comprise clustering the correlation vectors into clusters, and grouping the object images that correspond to the correlation vectors of each cluster into a respective one of the groups. The clustering of correlation vectors into clusters is done on the basis of the values of the correlation vectors, for example the clustering of the N length correlation vectors may be visualised by each correlation vector defining one point in an N dimensional space, the points then being separated into groups based on their proximities to one another within the N dimensional space.

Typically, the correlation vectors are each associated with a respective object image, and all of the object images corresponding to the correlation vectors that are clustered into a cluster are considered to be object images of a single object. Accordingly, each cluster is associated with a respective group into which the object images corresponding to the correlation vectors of the cluster are grouped. There are many clustering algorithms that are known in the art and which could be applied to cluster the correlation vectors into clusters, for example k-means, expectation-maximization, Gaussian mixture model, or Bayesian estimator, as will be apparent to those skilled in the art.

The object recognition process may comprise comparing each group of object images to a library of objects to determine which object the group of object images best correspond. Clearly, the library of objects may contain representations of objects, rather than the actual objects themselves. For example, if the objects are faces, the object images may be facial images, and the object recognition process may be a facial recognition process. The facial recognition process may comprise comparing each group of facial images to a library of faces to determine which face the group of facial images best correspond, for example by comparing each group of facial images to a library of faces that are represented by facial images and/or models of facial images.

According to a second aspect of the invention, there is provided a system for recognition of objects within a vided. The system comprises a processor and a memory connected to the processor, the memory configured to store a library of object images. The processor comprises an object detection module configured to detect object images in a video, an object grouping module configured to group object images into groups of object images that show the same object as one another, and an object recognition module configured to compare each group of object images to the library of objects to determine which object the group of object images best correspond. The object grouping module is further configured to determine comparison scores between pairs of the object images; determine correlation scores between the pairs of the object images, the correlation scores being correlations between the comparison scores; and group the object images into the groups of object images based on the correlation scores. The system may be further configured to perform any of the methods disclosed above in relation to the first aspect of the invention.

The object detection module, object grouping module, and object recognition module may for example be implemented as software modules running on a processor. The processor may be distributed over more than one location, for example if the object detection module, object grouping module, and object recognition module are software modules executed on different computers that are connected to one another, and the memory may be remote from the computers, for example accessible over a computer network. Alternatively, the object detection module, object grouping module, and object recognition module may be implemented as hardware modules.

### BRIEF DESCRIPTION OF THE DRAWINGS

Embodiments of the invention will now be described by way of example only and with reference to the accompanying drawings, in which:

FIG. 1 shows a flow diagram of a method for recognition of faces within a video, according to an embodiment of the invention;

FIG. 2 shows a schematic diagram of a system for performing face recognition according to the method of FIG. 1;

FIG. 3 shows a schematic diagram of a grouping module of the system of FIG. 2;

FIG. 4 shows a schematic diagram of a video sequence of three people;

FIG. 5a shows a comparison matrix calculated from the video sequence of FIG. 4;

FIG. 5b shows a graph of comparison score distributions corresponding to the FIG. 5a comparison matrix;

FIG. 6a shows a plotted view of the comparison matrix of FIG. 5a;

FIG. 6b shows a plotted view of a comparison matrix based on a longer and noisier video sequence;

FIG. 6c shows a graph of comparison score distributions corresponding to the FIG. 6b comparison matrix;

FIG. 7 shows a correlation matrix calculated from the comparison matrix of FIG. 5a;

FIG. 8a shows a plotted view of the correlation matrix of FIG. 7;

FIG. 8b shows facial images from the video sequence of FIG. 4 split into groups based on clustering correlation vectors of the correlation matrix of FIG. 7; and

FIG. 8c shows a plotted view of a correlation matrix calculated from the comparison matrix plotted in FIG. 6b;

The drawings are purely illustrative and are not to scale. Same or similar reference signs denote same or similar features.

### DETAILED DESCRIPTION

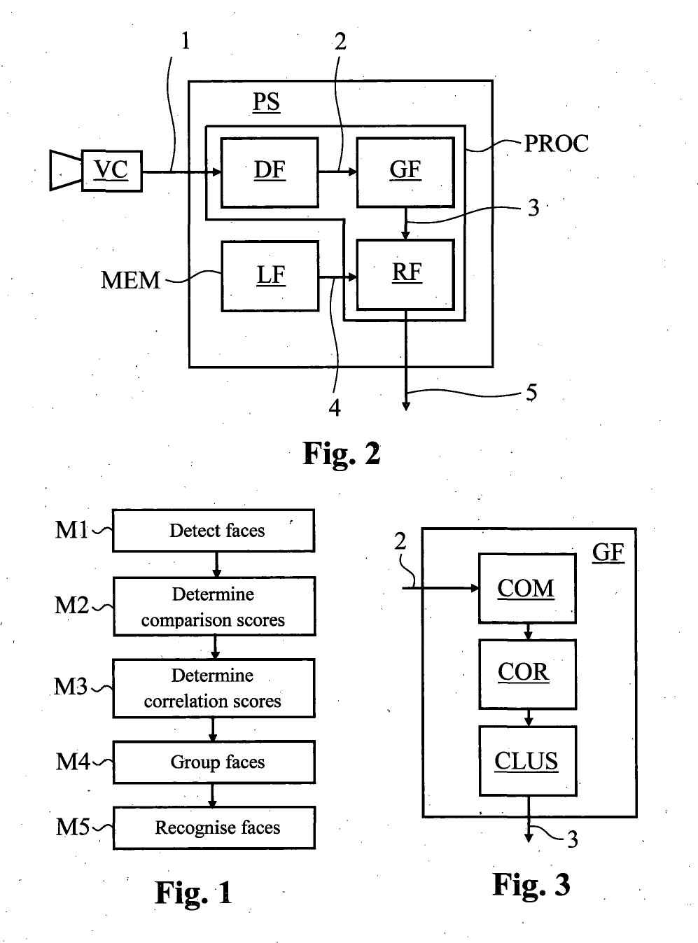

The flow diagram of FIG. 1 shows a method for performing recognition of, faces within a video according to an embodiment of the invention. The video comprises a plurality of video frames, and in a first step M1 a plurality of facial images are detected within the video frames.

In a second step M2, each one of the plurality of facial images is compared to every one of the plurality of facial images on a pair-by-pair basis to determine a comparison score between the two facial images of each pair.

Then, in a step M3, a correlation score is calculated for each one of the pairs of facial images, the correlation score calculated by correlating the comparison scores that were calculated using the first image of the pair with the comparison scores that were calculated using the second image of the pair.

Next, in a step M4, the object images are grouped into groups of object images that show the same object as one another based on the correlation scores. This step comprises comparing the correlation scores that were calculated using one of the plurality of facial images, to the correlation scores that were calculated using each other one of the plurality of facial images, and grouping facial images that were used to calculate similar correlation scores together.

Finally, in a step M5, the facial images of one of the groups are used as facial images of a single face in a facial recognition process, to help recognise the face. The facial recognition process compares the facial images of the one of the groups to a library of facial images, to help determine which facial image in the library best corresponds to the facial images of the group.

In alternative embodiments, the method could easily be adapted to recognise other types of objects instead of faces. For example, the step M1 could be modified to detect images of vehicles within video frames, the vehicle images could be compared in step M2, the comparison scores correlated in step M3, the vehicle images grouped in step M4, and the vehicle images of one of the groups used as images of a single vehicle in a vehicle recognition process in step M5, the vehicle recognition process comparing the vehicle images of the group to a library of vehicle images, to help determine which vehicle image in the library best corresponds to the vehicle images of the group.

The schematic diagram of FIG. 2 shows a system for performing face recognition according to the method of FIG. 1. The system comprises a video camera VC, and a processing system PS for processing video frames 1 from the video camera. The processing system PS in this embodiment is a computer comprising a processor PROC and a memory MEM. The processor PROC comprises a face detection module DF, a face grouping module GF, and a face recognition module RF. These modules may for example be software modules that are defined in the processor by computer software that is run on the processor. Alternatively, these modules may be hardware modules that are hardwired in an application specific integrated circuit (ASIC) or field-programmable gate array (FPGA), as will be apparent to the skilled person. The memory MEM stores a library LF of facial images, and may for example be formed of hard disk drive(s) and/or solid state storage module(s).

The face detection module DF is configured to receive video frames and detect M1 facial images 2 within the video frames 1. The face grouping module GF is configured to receive facial images 2 from the face detection module DF, and to group M2, M3, M4 facial images that are of the same face into groups 3. The face recognition module RF is configured to receive groups 3 of facial images from the face detection module DF, and for each group to recognise M5 the face that the facial images within the group show. The face recognition module RF recognises the face that the facial images 2 within the group correspond to, by comparing the facial images of the group to the facial images 4 in the library LF, and determining which one of the facial images 4 in the library LF best correspond to the facial images 2 within the group. Once the facial image 4 has been determined, it, or a label corresponding to it, such as the identity of the person associated with the facial image 4, is output 5.

In alternative embodiments where other types of objects are being detected, for example text objects, the face detection module DF may instead be a text detector, the face grouping module GF may instead be a text grouping module, and the face recognition module RF may instead be a text recognition module.

The schematic diagram of FIG. 3 shows the face grouping module GF of FIG. 2 in more detail. The face grouping module GF comprises a comparison module COM, a correlation module COR, and a clustering module CLUS. The comparison module COM receives the facial images 2 and compares each facial image 2 to every other facial image 2 on a pair-by-pair basis to calculate M2 a comparison score between each pair of facial images. The comparison scores are output to the correlation module COR which calculates. M3 correlation scores between the comparison scores, and then the correlation scores are output to the clustering module CLUS, which clusters the correlation scores into clusters based on the correlation score values. The facial images that correspond to the correlation scores of each cluster are grouped M4 together as a group of facial images 3 of the same face.

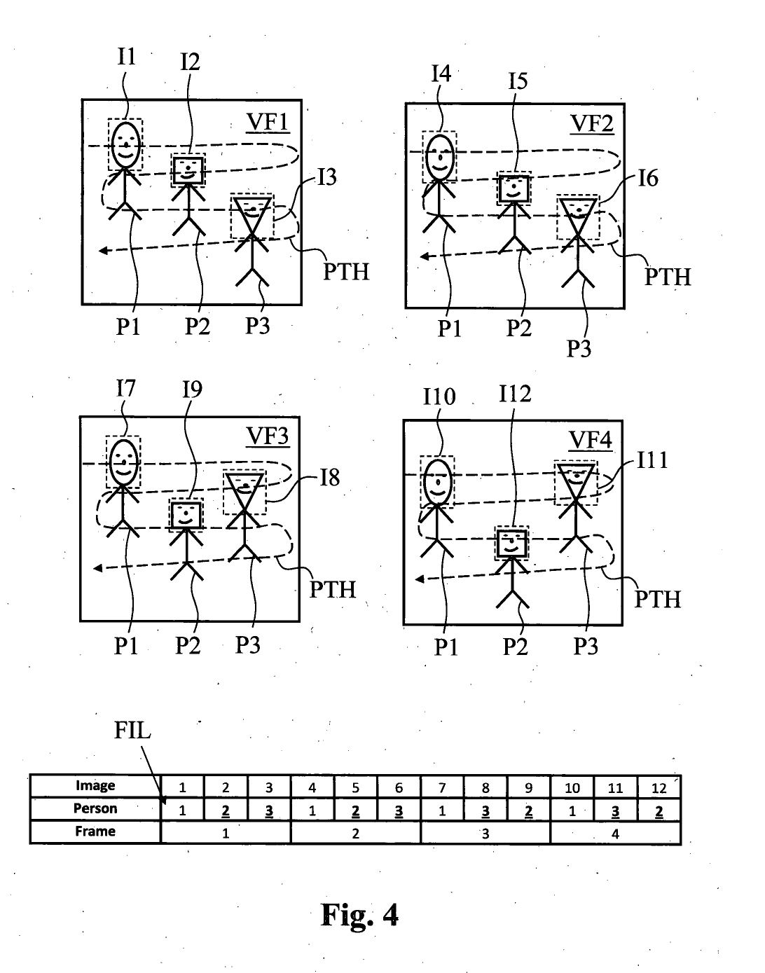

The operation of the face detection module DF will now be described in more detail with reference to FIG. 4, which shows a sequence of four video frames VF1, VF2, VF3, and VF4 of the video 1. For each successive video frame that the face detection module DF receives, the face detection module DF progressively scans through the video frame searching for facial images. Each time a facial image is detected, the facial image is added to a vector of facial images. Once all of the facial images in all of the frames have been detected, the vector of facial images will include all of the facial images in the order in which they were encountered in the video.

In this embodiment, the face detection module DF uses a Haar wavelet face detection algorithm, although other known types of face detection algorithms could alternatively be used, as will be apparent to those skilled in the art. The face detection module progressively scans through each video frame along a path PTH that is generally indicated in FIG. 4 as sweeping left and right across, the video frame, from top to bottom of the video frame.

In the first video frame VF1, the face detection module DF scanning along the path PTH firstly detects the face of the person P1 and stores a facial image I1 of the face in a facial image list, secondly detects the face of the person P2 and adds the facial image I2 of the face to the facial image list, and thirdly detects the face of the person P3 and adds the facial image I3 of the face to the facial image list.

In the second video frame VF2, the face detection module DF scanning along the scanning path PTH firstly detects the face of the person P1 and adds the facial image I4 of the face to the facial image list, secondly detects the face of the person P2 and adds the facial image I5 of the face to the facial image list, and thirdly detects the face of the person P3 and adds the facial image I6 of the face to the facial image list.

In the third video frame VF3, the person P3 has moved further up the frame and the person P2 has moved further down the frame, such that as the face detection module DF scans along the path PTH the face of the person P3 is detected before the face of the person P2. Accordingly, a facial image I7 of person P1, then a facial image I8 of person P3, and then a facial image I9 of person P2 is added to the facial image list.

In the fourth video frame VF4, the face detection module DF scanning along the path PTH firstly detects the face of the person P1 and adds the facial image I10 of the face to the facial image list, secondly detects the face of the person P3 and adds the facial image I11 of the face to the facial image list, and thirdly detects the face of the person P2 and adds the facial image I12 of the face to the facial image list.

The fourth video frame VF4 is the last video frame in the video, and so the facial image list FIL comprising the facial images I1-I12 is output to the face grouping module GF. For ease of understanding, the facial image list FIL is shown in FIG. 4 with labels in brackets indicating which person P1, P2, or P3 each facial image I1-I12 corresponds to, although clearly in practice the person to which each facial image corresponds is not known at this stage of the method and is to be determined by the system from the facial images I1-I12.

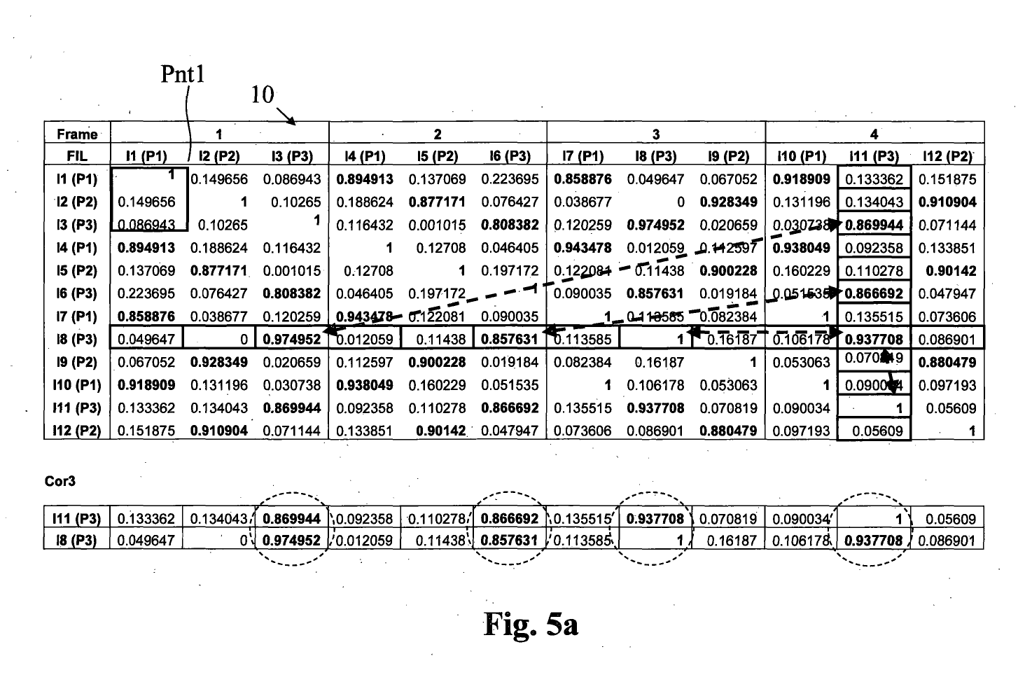

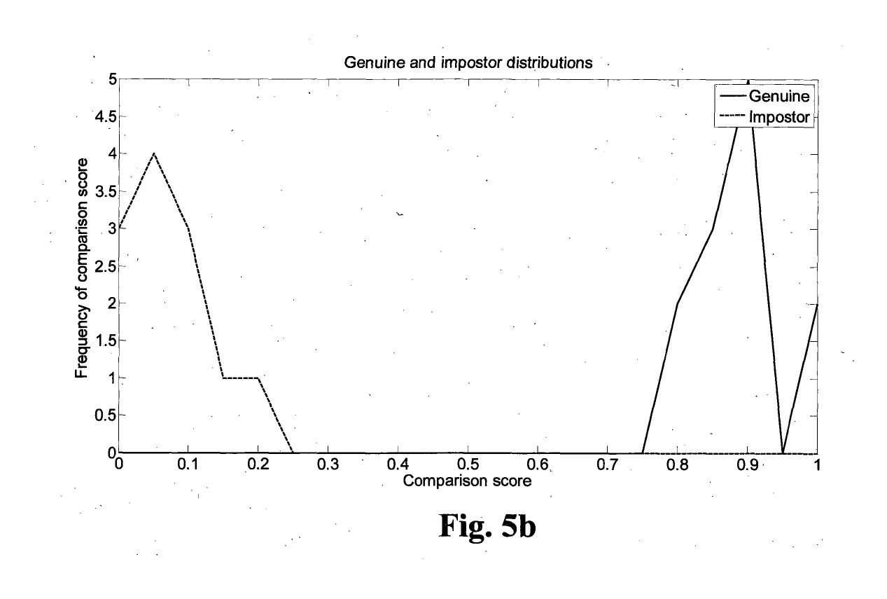

The operation of the face grouping module GF will now be described in more detail with reference to FIGS. 5a-8c. The face grouping module GF receives the facial image list FIL from the face detection module DF, and then the comparison module COM compares each facial image to every other facial image and the resulting comparison scores are stored in a comparison matrix 10 as shown in FIG. 5a. Each row, and each column forms a comparison vector of the comparison scores between the facial image corresponding to the row/column and the other facial images. For example, the column for the facial image I5 shows the comparison score between I5 and I1 as 0.137069, then the comparison score between I5 and I2 as 0.877171, then the comparison score between I5 and I3 as 0.001015, and so on for I4-I12. Note that the row for the facial image I5 has the same values as the column for the facial image I5.

Each comparison score is calculated with a value ranging between 0 and 1, where 0 corresponds to a 0% match between the two facial images and 1 corresponds to a 100% match between the two facial images. For example, it can be seen in FIG. 5a that the comparison between facial images I1 and I7, which are both of the same person P1, yields a fairly high comparison score of 0.858876, and that the comparison between facial images I1 and I8, which are of two different people P1 and P3 respectively, yields a fairly low comparison score of 0.049647. The high comparison scores are highlighted in bold to aid understanding.

A graph of the imposter and genuine comparison score distributions that correspond to the comparison matrix of FIG. 5a is shown in FIG. 5b. The video frames VF1-VF4 are high quality and show full frontal views of the faces of the persons. Accordingly, the comparison scores are high quality and there is no overlap between the imposter and genuine comparison scores. All the comparisons between images that are of the same face (genuine comparisons) have resulted in comparison scores greater than 0.75, and all the comparisons between images that are of different faces (imposter comparisons) have resulted in comparison scores less than 0.25.

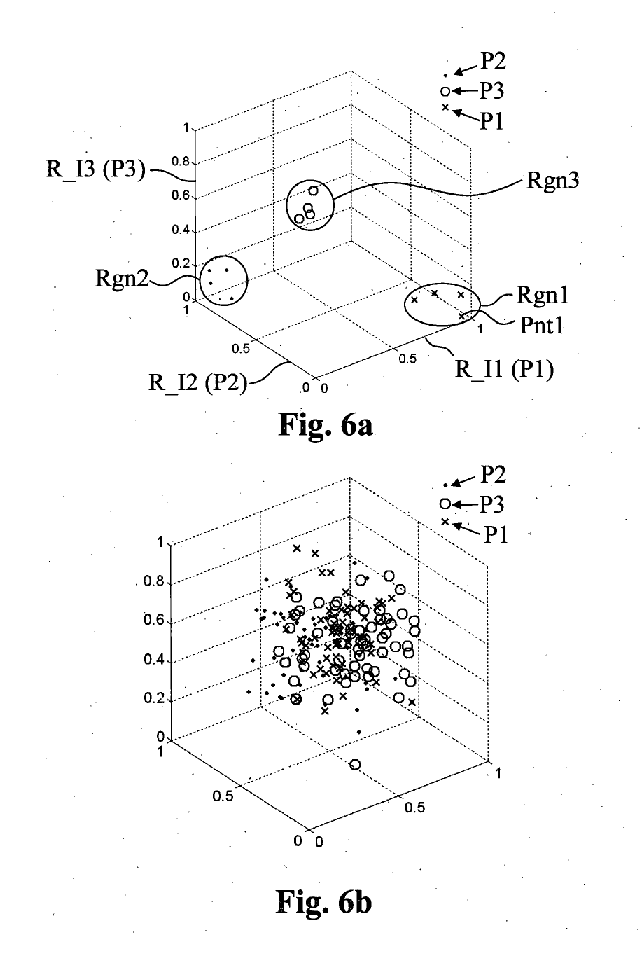

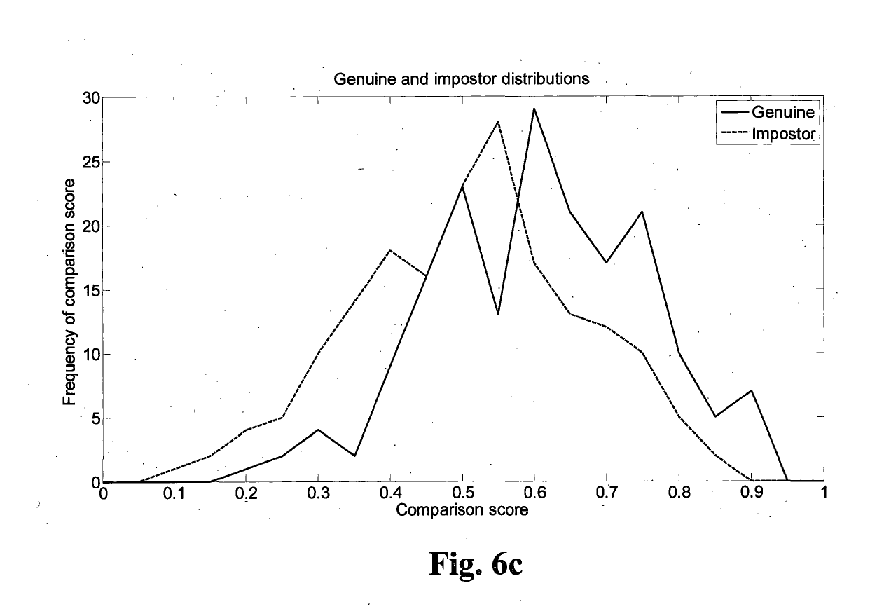

A plotted view of the comparison scores of FIG. 5a is shown in FIG. 6a. Each column in the comparison matrix of FIG. 5a (comparison vector) defines one point in a 12 dimensional space; the 12 dimensions corresponding to the 12 rows of the comparison matrix. To enable the comparison vectors to be visualised, the plotted view of FIG. 6a only plots the comparison vectors in three dimensions R_I1 (P1), R_I2 (P2), and R_I3(P3), corresponding to the first three rows I1 (P1), I2(P2), and I3(P3) of the comparison matrix respectively. For example, the point Pnt1 marked on FIG. 6a is defined by the column vector [1, 0.149656, 0.086943] indicated on FIG. 5a. The point Pnt1 corresponds to the facial image I1, since the point Pnt1 is based on the column in the comparison matrix that corresponds to the facial image I1.

Since the comparison scores are high quality with no, overlap between the imposter and genuine comparison scores, they are clearly delimited into three separate regions Rgn1, Rgn2, and Rgn3 of the plotted view corresponding to the three respective persons P1, P2, and P3. Therefore, for such high quality data, it is possible to identify the facial images that are of a single person based on the comparison scores alone.

However, the facial images extracted from video frames of real video are often of much lower quality, and there may be a much larger overlap between genuine comparison scores and imposter comparison scores, such that looking at the comparison scores alone does not allow the facial images that are of a single person to be identified.

The plotted view of FIG. 6b shows comparison scores between facial images of the three people P1, P2, and P3, the facial images being taken from a much longer and noisier video sequence. It can be seen that the facial images plotted on FIG. 6b do not fall into three distinct regions, due to the overlap between genuine comparison scores and imposter comparison scores. A graph of the imposter and genuine comparison score distributions is shown in FIG. 6c. It can be seen that there is a very large overlap between the imposter and genuine comparison score distributions, meaning that separating the images into groups corresponding to respective persons is very difficult based on comparison scores alone. The comparison matrix used to generate FIGS. 6b & 6c plots is not shown herein due to its very large size of 150 rows by 150 columns, which correspond to three facial images detected in each one of 50 video frames.

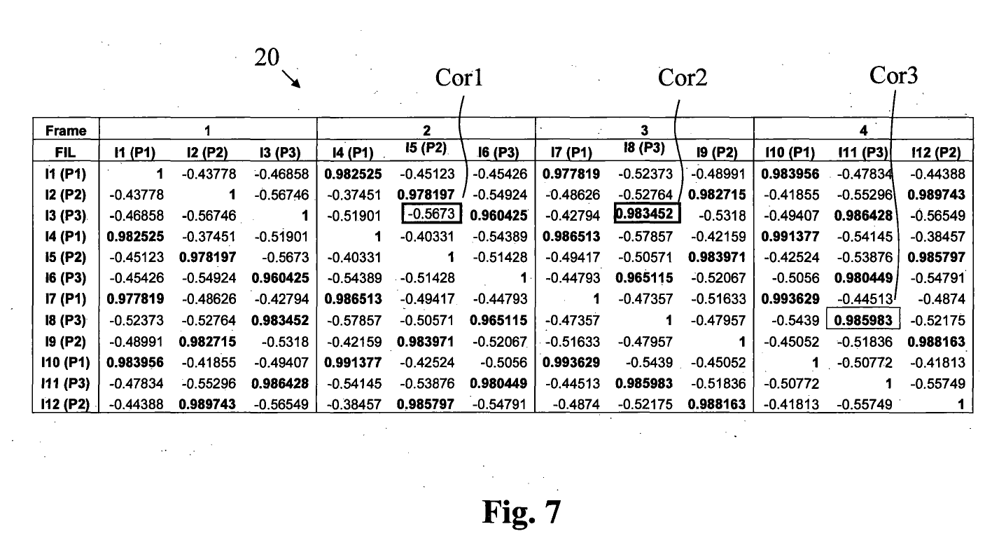

The calculation of a correlation matrix to improve the separation of genuine comparison scores and imposter comparison scores will now be described with reference to FIG. 7. The comparison module COM outputs the comparison matrix 10 of FIG. 5a to the correlation module COR, and the correlation module COR calculates a correlation matrix 20 from the comparison matrix 10. The correlation matrix 20 is shown in FIG. 7, and for each comparison score of the FIG. 5a comparison matrix, the row of the comparison matrix in which the comparison score appears is correlated with the column of the comparison matrix in which the comparison score appears, to produce a correlation score that is stored in a corresponding position of the correlation matrix 20.

Specifically, to calculate the correlation score matrix from the comparison score matrix, firstly the following covariance formula is calculated for each location in the comparison matrix:

$$Cov ( x , y ) = \frac{1}{N} {\sum }_{i = 1}^{N} ( {∅}_{x , i} - \overline{{∅}_{x}} ) ( {∅}_{i , y} - \overline{{∅}_{y}} )$$

wherein x is the row number, y is the column number, Ø_{xy} is the value of the comparison score at row x column y of the comparison matrix, Ø̅ₓ is the mean of the comparison scores along row x of the comparison matrix, Ø̅_{y} is the mean of the comparison scores along column y of the comparison matrix, and N is the number of rows and columns, which in this embodiment is 12.

Secondly, the following formula is calculated for each location in the comparison matrix to normalise the matrix, producing the correlation matrix 20 shown in FIG. 7:

$$R ( x , y ) = \frac{cov ( x , y )}{\sqrt{cov ( x , x ) cov ( y , y )}}$$

Accordingly, each comparison vector is correlated with every other comparison vector. The correlation scores in the correlation matrix vary between −0.58 for a low correlation between image pairs, up to 1 for a high correlation between image pairs. For example, the correlation score Cor1 of −0.5673 in row x=3 and column y=5 is calculated by correlating the comparison vector of 12 comparison scores along row x=3 (labelled as I3 (P3) in FIG. 5a) with the comparison vector of 12 comparison scores along column y=5 (labelled as (I5, (P2) in FIG. 5a).

The correlation score Cor1 is a low score of −0.5673 because the comparison scores between the image I3 and the images I1-I12 (FIG. 5a row I3(P3)) do not vary in the same way as the comparison scores between I5 and I1-I12 (FIG. 5a column I5(P2)). This is expected because the images I3 and I5 to which the correlation score Cor1 corresponds are images of two different people P3 and P2 respectively. If the images I3 and I5 were of the same person, then the correlation score would have been expected to be higher. For example, the images I3 and I8 are of the same person P3, and the correlation score Cor2 corresponding to them is 0.983452.

Each row and each column of the correlation matrix 20 forms a correlation vector of the correlation scores between the facial image corresponding to the row/column and the other facial images. For example, the column for the facial image I5 shows the correlation score between I5 and I1 as −0.45123, then the correlation score between I5 and I2 as 0.978197, then the correlation score between I5 and I3 as −0.5673, and so on for I4-I12. Note that the row for the facial image I5 has the same values as the column for the facial image I5. The high correlation scores are highlighted in bold to aid understanding.

The step of determining the correlation score is figuratively illustrated in FIG. 5a, where a correlation score is determined for image 11 and image 8, where the higher comparison scores (highlighted in bold) in the column under image 11 (optionally a comparison vector of image 11) and in the row of image 8 (optionally a comparison vector of image 8) are correlated, and where it can be seen that the higher comparison scores appear in the same order in both sequences (e.g. the two comparison vectors)—as shown more clearly below the main table in FIG. 5a. This correlation gives rise to a high correlation score of 0.985983 (shown in FIG. 7 as Cor3). The correlation scores in (as shown in FIG. 7) are more strongly distinguishable into two distinct groups (either being high or low values), as compared to the comparison scores (as shown in FIG. 5a) where the distinction is less clear (in this particular example even the comparison scores are reasonably clear, however the example used was that was not a particularly challenging one for ease of illustration), This enables a higher confidence that image 11 and image 8 are of the same object (e.g. face) as using the comparison scores alone, particularly in circumstances where it may be otherwise difficult to achieve high confidence of the this.

Although a specific formula for the calculation of the correlation matrix has been given above, it will be appreciated that other formulas are also known in the art for calculating how well two vectors correlate with one another, and could be used instead of the specific formula given above.

The correlation module COR outputs the correlation matrix 20 to the clustering module CLUS, and the clustering module clusters the correlation vectors of the correlation matrix into clusters of similar valued correlation vectors. Specifically, each correlation vector (column) in the correlation matrix of FIG. 7 defines one point in a 12 dimensional space, the 12 dimensions corresponding to the 12 rows of the correlation matrix 20. The correlation vectors are clustered into clusters of correlation vectors based on the proximities of the correlation vectors to one another within the 12-dimensional space.

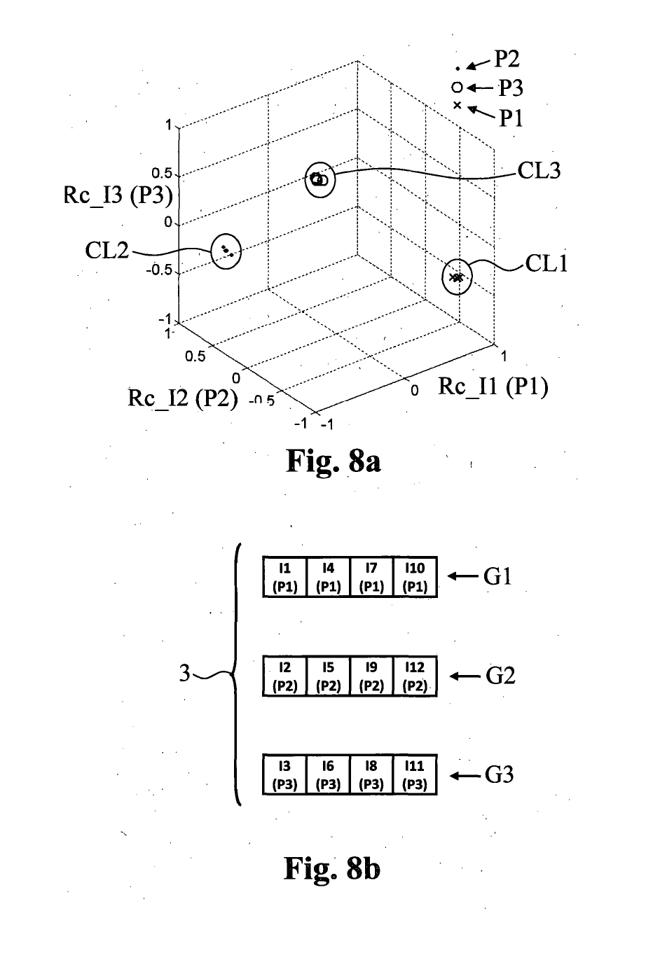

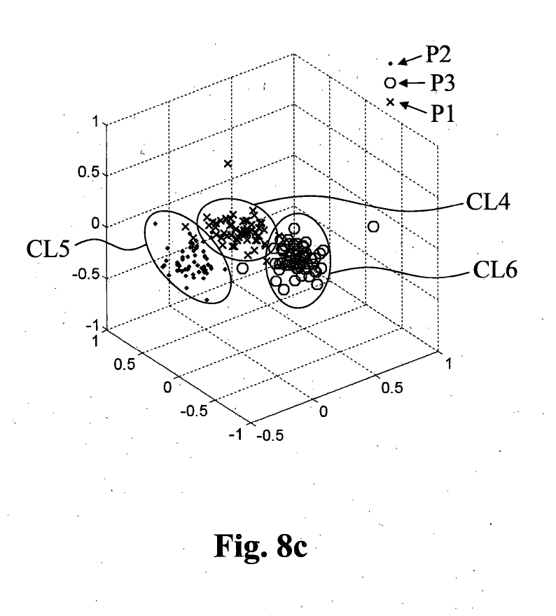

To enable the clustering of the correlation vectors to be visualised, a plotted view of the correlation vectors (columns) of the FIG. 7 correlation matrix is shown in FIG. 8a. The plotted view of FIG. 8a only plots the correlation vectors in three dimensions Rc_I1(P1), Rc_I2 (P2), and Re_I3(P3), which is sufficient to illustrate the clustering. Rc_I1(P1), Rc_I2 (P2), and Rc_I3(P3) correspond to the first three rows I1(P1), I2(P2), and I3(P3) of the correlation matrix respectively. The points plotted as crosses correspond to columns associated with images of person. P1 and form a cluster CL1, the points plotted as dots correspond to columns associated with images of person P2 and form a cluster CL2, and the points plotted as circles correspond to columns associated with images of person P3 and form a cluster CL3. The clustering of the correlation vectors into the three clusters CL1, CL2, and CL3 is performed by a k-means clustering algorithm, as will be apparent to those skilled in the art, although other types of clustering algorithm could alternatively be used.

The cluster CL1 consists of points that correspond to the FIG. 7 correlation vectors (columns) I1 (P1), I4 (P1), I7 (P1), I10(P1), the cluster CL2 consists of points that correspond to the FIG. 7 correlation vectors (columns) I2 (P2), I5 (P2), I9 (P2), I12(P2), an the cluster CL3 consists of points that correspond to the FIG. 7 correlation vectors (columns) I3 (P3), I6 (P3), I8 (P3), I11(P3).

The clustering module CLUS then outputs three groups 3 of images to the face recognition module RF, each group including the images that correspond to the correlation vectors of a respective cluster. As shown in FIG. 8b, the first group G1 of images is I1, I4, I7, and I10, which corresponds to the cluster CP1 of correlation vectors, the second group G2 of images is I2, I5, I9, and I12, which corresponds to the cluster CP2 of correlation vectors, and the third group G3 of images is I3, I6, I8, and I11, which corresponds to the cluster CP3 of correlation vectors.

The face recognition module RF receives the three groups of images G1-G3 and successively compares each group of images to the library LF. The library LF includes high quality facial images 4 of the persons P1, P2, and P3, and so the face recognition module RF is able to determine that the group G1 shows images of the person P1, that the group G2 shows images of the person P2, and that the group G3 shows images of the person P3, and so outputs 5 the identities of the persons P1, P2, and P3.

It can be seen by comparing FIG. 8a with FIG. 6a that the calculations of correlation scores has resulted in the correlation scores of FIG. 8a being much, more closely grouped together than the comparison scores of FIG. 6a. For example, the plotted crosses on FIG. 6a corresponding to P1 are much more widely spaced than the plotted crosses on FIG. 8a corresponding to P1.

In the FIG. 8a example, the closer grouping provided by the calculation of correlation scores does not have much impact on the final image groupings since there is no overlap between imposter and genuine comparison scores (FIG. 5a). However, for comparison matrixes that have overlapping imposter and genuine distributions, such as plotted in FIG. 6b, the correlation step enables much more effective grouping of images to be carried out.

In particular, the plotted view of FIG. 8c shows a plot of a correlation matrix, the correlation matrix being calculated from the comparison matrix plotted on FIG. 6b. The size of the correlation matrix is too large to reproduce herein, however it can be seen on FIG. 8c that the correlation step largely separates the overlapping dots, crosses and circles of FIG. 6b into separate regions, enabling the correlation vectors (columns) of the correlation matrix to be clustered into clusters CL4, CL5, and CL6 corresponding to the persons P1, P2, and P3 respectively. The clusters CL4, CL5, and CL6 are distinct from one another, and only appear to overlap in FIG. 8c due to the two-dimensional representation of the three-dimensional graph.

The images corresponding to the correlation vectors of cluster CL4 can be output as a group of images of one person, the images corresponding to the correlation vectors of cluster CL5 can be output as a group of images of another person, and the images corresponding to the correlation vectors of cluster CL6 can be output as a group of images of still another person, and the groups can be used in a facial recognition process to identify that the persons P1, P2, and P3 appear in the longer and noisier video sequence.

For clarification, the step of “detecting a plurality of object images present in the video frames” generally includes detecting object images within each of a plurality of frames, with at least some frames containing multiple object images. Typically there may be in excess of 100 object images distributed across more than 30 video frames, and often far more object images and video frames.

Further embodiments falling within the scope of the appended claims will also be apparent to the skilled person.

1. A method for recognition of objects within a video, the video comprising a plurality of video frames, the method comprising:
detecting a plurality of object images present in the video frames;
determining comparison scores between pairs of the object images;
determining correlation scores between pairs of the object images, the correlation scores being correlations between the comparison scores;
grouping the object images into groups of object images that show the same object as one another based on the correlation scores; and
for at least one of the groups, using the object images of the group as object images of a single object in an object recognition process.

2. The method of claim 1, wherein detecting object images present in the video frames comprises detecting object images along a scanning path across each video frame, the scanning paths across each video frame being the same as one another.

3. The method of claim 1, wherein the plurality of object images are arranged into an object image list in an order corresponding to an order in which the object images are detected from the video frames.

4. The method of claim 1, wherein determining comparison scores between pairs of the object images comprises determining a comparison vector for each object image, the comparison vector comprising comparison scores between the object image and the other object images.

5. The method of claim 4, wherein the plurality of object images consists of N object images, wherein the object image list is an N length object image list; and wherein determining comparison scores between pairs of the object images comprises determining an N:N comparison matrix containing comparison scores between each one of the plurality of object images and every other one of the plurality of object images, the rows and columns of the N:N comparison matrix defining the comparison vectors.

6. The method of claim 1, wherein a first pair of the pairs of the object images comprises a first object image and a second object image, and wherein determining the correlation score between the first pair of the object images comprises correlating the comparison scores between the first object image and the plurality of object images, with the comparison scores between the second object image and the plurality of object images.

7. The method of claim 1, wherein determining correlation scores between pairs of the object images comprises determining a correlation vector for each object image, the correlation vector comprising correlation scores between the comparison scores of the object image and the comparison scores of the other object images.

8. The method of claim 7, wherein determining correlation scores between pairs of the object images comprises determining correlation scores between pairs of the comparison vectors.

9. The method of claim 8, wherein determining correlation scores between pairs of the object images comprises determining an N:N correlation matrix containing correlation scores between each one of the comparison vectors and every other one of the comparison vectors, the rows and columns of the N:N correlation matrix defining the correlation vectors.

10. The method of claim 7, wherein grouping the object images into groups comprises clustering the correlation vectors into clusters, and grouping the object images that correspond to the correlation vectors of each cluster into a respective one of the groups.

11. The method of claim 10, wherein clustering correlation vectors into clusters comprises clustering the correlation vectors based on a k-means clustering algorithm, an expectation-maximisation clustering algorithm, a Gaussian mixture model clustering algorithm, or a Bayesian estimator clustering algorithm.

12. The method of claim 1, wherein the object recognition process comprises comparing each group of object images to a library of objects to determine which object the group of object images best correspond.

13. The method of claim 1, wherein the objects are faces, wherein the object images are facial images, and wherein the object recognition process is a facial recognition process.

14. The method of claim 13, wherein the facial recognition process comprises comparing each group of facial images to a library of faces to determine which face the group of facial images best correspond.

15. A system for recognition of objects within a video, the system comprising a processor and a memory connected to the processor, the memory configured to store a library of object images and the, processor comprising an object detection module configured to detect object images in a video, an object grouping module configured to group object images into groups of object images that show the same object as one another, arid an object recognition module configured to compare each group of object images to the library of objects to determine which object the group of object images best correspond, wherein the object grouping module is further configured to:
determine comparison scores between pairs of the object images;
determine correlation scores between pairs of the object images, the correlation scores being correlations between the comparison scores; and
group the object images into the groups of object images based on the correlation scores.

16. (canceled)
